(19) United States
(12) Patent Application Publication
(10) Pub. No.: US 2011/0146258 A1
(43) Pub. Date: Jun. 23, 2011

(54) Hydraulic Circuit

(76) Inventor: Josef Peters, Mannheim (DE)

(21) Appl. No.: 12/823,754

(22) Filed: Jun. 25, 2010

(30) Foreign Application Priority Data
Aug. 21, 2009 (DE) 10 2009 028 816.3

(51) Int. Cl. F15B 11/16

(52) U.S. Cl. 60/422

(57) ABSTRACT

A hydraulic circuit includes a pump and at least a first, second and third actuator, supplied on demand by the pump via respective load pressure lines. Each actuator is connected to the pump by a respective control valve and supply line. A first, second and third supply priorities are assigned respectively to the first, second and third actuators. In order to safeguard priority of the actuators, and to control the supply priority levels, the supply lines of the second and third actuators are connected to each other via a connecting line, and a load pressure-controlled priority valve is arranged between the pump and the connecting line in the supply line to the third actuator. Also, a flow-reducer is placed in the supply line to the second actuator). The connecting line also includes a check valve which prohibits flow from the second supply line to the third supply line.

### FIELD OF THE INVENTION

The present invention relates to a hydraulic circuit having a hydraulic pump and at least a first, second and third actuators, supplied on demand by the hydraulic pump via respective load pressure lines.

### BACKGROUND OF THE INVENTION

It is known to provide hydraulic systems with load pressure-dependent supplies for individual hydraulic actuators, for agricultural vehicles such as agricultural tractors, for example, but also in harvesters and construction and forestry machines. Such systems, also known as load sensing systems, can be operated both with constant-delivery pumps and with variable-delivery pumps having a regulated volumetric delivery rate. Where constant-delivery pumps are used, a load pressure-dependent supply is achieved in that a constant volumetric delivery rate is evacuated via an evacuation line as a function of the load pressure. Variable-delivery pumps on the other hand can be directly operated as a function of the load pressure. Another known method is to control the supply to the actuators on said vehicles according to priority, so that should operation result in a hydraulic supply shortfall, hydraulic, actuators with a higher priority level have priority of hydraulic supply over actuators with a lower priority level. Thus actuators such as hydraulically operated steering or hydraulically operated brake systems, for example, are of a higher priority level than a hydraulically operated vehicle suspension, for example. In turn the latter may likewise be of a higher priority level compared to another actuator, for example a lifting gear situated on the vehicle. Thus in a load pressure-dependent hydraulic system account often has to be taken of multiple priority levels for the various actuators.

In order to achieve a reliable priority control, use is made in hydraulic load-sensing systems of priority valves in the form of pressure-maintaining valves, which serve to control an order of priority in the supply of individual actuators in the event of a hydraulic supply shortfall of the overall system. The individual actuators are generally each connected to at least one control valve, which serves to control an inlet of the volumetric delivery rate from the hydraulic pump. Situated in the inlet of each control valve is a priority valve, which is closed by a load pressure signal of a priority actuator and which reduces or restricts the flow, in order to ensure the hydraulic supply to the priority valves. Thus in order to achieve two priority levels in the hydraulic systems or assemblies known in the prior art, one priority valve is used. In order to achieve three priority levels, as mentioned above, therefore, two priority valves are usually needed. This is generally associated with an increased construction outlay and overall volume. If it is desirable to avoid this, corresponding priority levels must be dispensed with, so that the various lower ranking actuators are often combined into one priority level, in order to save using a further priority valve associated with build costs and overall volume. In the event of a supply shortfall of the overall system, however, this may mean that one of the combined actuators experiences an inadequate flow supply and therefore fails. This is particularly detrimental when it is a actuator which should enjoy an actually higher priority of supply than a actuator combined in the same priority level.

### SUMMARY

Accordingly, an object of this invention is to provide a simple hydraulic circuit which achieves multiple priority levels for actuators.

This and other objects are achieved by the present invention, wherein According to the invention a hydraulic circuit of the type specified in the introductory part is embodied in such a way that for controlling the supply priority levels the supply lines of the second and third actuators are connected via a connecting line and a load pressure-controlled priority valve is arranged between the hydraulic pump and the connecting line in the supply line to the third actuator and flow-reducing means are arranged in the supply line to the second actuator, the connecting line furthermore comprising means which prohibit a flow from the second supply line in the direction of the third supply line. Under normal supply conditions of the overall system a flow delivered by the hydraulic pump is in each case able to pass, unimpeded or unrestricted, via the first supply line to the first actuator, via the priority valve, the connecting line and the second supply line to the second actuator and via the priority valve and the third supply line to the third actuator. In the event of a supply shortfall of the overall system, the priority valve closes owing to the connection to the load pressure lines and prevents or reduces a flow flowing through the priority valve to the second and third actuators. At the same time the flow through the second supply line is led via the flow-reducer, a flow via the connecting line being prohibited by the means located there. The second actuator therefore continues to be hydraulically supplied, albeit with a restricted flow, irrespective of the position of the priority valve, even if the priority valve should be fully closed. In the event of a supply shortfall of the overall system, therefore, a minimum supply is delivered to the second actuator with a defined flow via the flow-reducer. This allows a build-up of pressure for the second actuator and ensures its minimum function. With increasing closure of the priority valve, the third actuator is supplied with an ever smaller flow, whereas the first actuator continues to be supplied at maximum flow. Owing to the flow-reducer, a higher supply priority attaches to the first actuator than to the second actuator. The second actuator moreover enjoys a higher supply priority than the third actuator, since a minimum flow for the second supply line is ensured even if the priority valve should be fully closed. Three priority levels are therefore established using just one priority valve. The flow-reducer can be preset so that a minimum flow to the second actuator is guaranteed, whilst at the same time ensuring that in no operating state can a supply shortfall of the first actuator occur due to a flow running off via the second supply line. A hydraulic circuit is thereby created, which compared to corresponding solutions known in the prior art has a smaller overall volume and lower component costs.

For load pressure-dependent control of the hydraulic circuit a load pressure line connected to the first actuator and a load pressure line connected to the second actuator are led via a first shuttle valve into a first resulting load pressure line, a first control pressure line driving the priority valve in the direction of a closed position being connected to the first resulting load pressure line. A second control pressure line, which drives the priority valve in the direction of an open position, is also provided, said line being connected on the hydraulic pump side to one of the supply lines.

In addition, the first resulting load pressure line and a load pressure line connected to the third actuator are combined via a second shuttle valve into a second resulting load pressure line, the second resulting load pressure line delivering a control pressure, which can be used to control a supply pressure provided by the hydraulic pump for the actuator supplied on demand as a function of the load.

The flow-reducer in the second supply line comprise a constant restrictor or orifice plate, or an orifice plate valve, for example. A variable or a manually or electronically adjustable or controllable orifice plate valve or flow control valve, or a throttle control valve may also be used here. Other means not specified here may also be used for reducing the flow. The essential point is that a minimum admissible flow can be preset, adjusted or controlled.

The means provided in the connecting line comprise a non-return valve closing in the direction of the third supply line. This may be a conventional ball valve, for example, which opens only in one direction of flow.

The pressure-controlled priority valve may be embodied as a proportional valve, the proportional valve constituting a pressure-controlled valve having intermediate positions and two limit positions—a closed position and an open position. As a function of the load pressure state (load pressure signal or load-sensing signal) from the individual actuators, the proportional valve assumes an intermediate position, which lies between a fully closed position and a fully opened position.

The hydraulic pump may be embodied as a load pressure-dependent variable-delivery pump, which via a preferably integral volumetric delivery rate controller delivers a variable flow as a function of the load pressure signal sent by the actuators, a load pressure supplied or signalled according to the second resulting load pressure line being used to control the variable-delivery pump.

In an alternative embodiment a constant-delivery pump may be used as hydraulic pump in place of the variable-delivery pump, a proportional valve controllable as a function of the load pressure then being provided, which as a function of the load pressure evacuates supply fluid delivered by the constant-delivery pump to a hydraulic tank. The required supply quantity for the actuators is signalled via the load pressure lines and as a function of this a corresponding proportion of the constant flow delivered by the constant-delivery pump is evacuated via the proportional valve into the hydraulic tank. A load pressure-dependent volumetric delivery can thereby be supplied to the actuators in a manner comparable to a variable-delivery pump.

The first actuator comprises a hydraulically operated steering or a hydraulically operated brake. Both of these together may furthermore also be provided in the same highest supply priority level. It is furthermore also possible to operate yet other actuators as first actuator with the highest priority level, for example a hydraulically operated transmission.

The second actuator may comprise a hydraulically operated suspension, this possibly being a cab suspension or also a vehicle axle suspension, for example. Other actuators may furthermore also be operated as second actuator with a subordinate priority level.

The third actuator, for example, may comprise a hydraulically operated lifting gear, for example, with a three-point hitch located at the front or rear of the vehicle, or a front loader mounted on the vehicle.

In the embodiments cited above the hydraulic circuit according to the invention is suited to use in agricultural vehicles, for example agricultural tractors, but also in harvesters, and construction and forestry machines.

### BRIEF DESCRIPTION OF THE DRAWINGS

FIG. 1 is a schematic side view of an agricultural vehicle having a hydraulic circuit according to the invention;

FIG. 2 is schematic hydraulic circuit diagram of a hydraulic circuit according to the invention having a variable-delivery pump; and

FIG. 3 is a schematic hydraulic circuit diagram of a hydraulic circuit according to the invention having a constant-delivery pump.

### DESCRIPTION OF THE PREFERRED EMBODIMENT

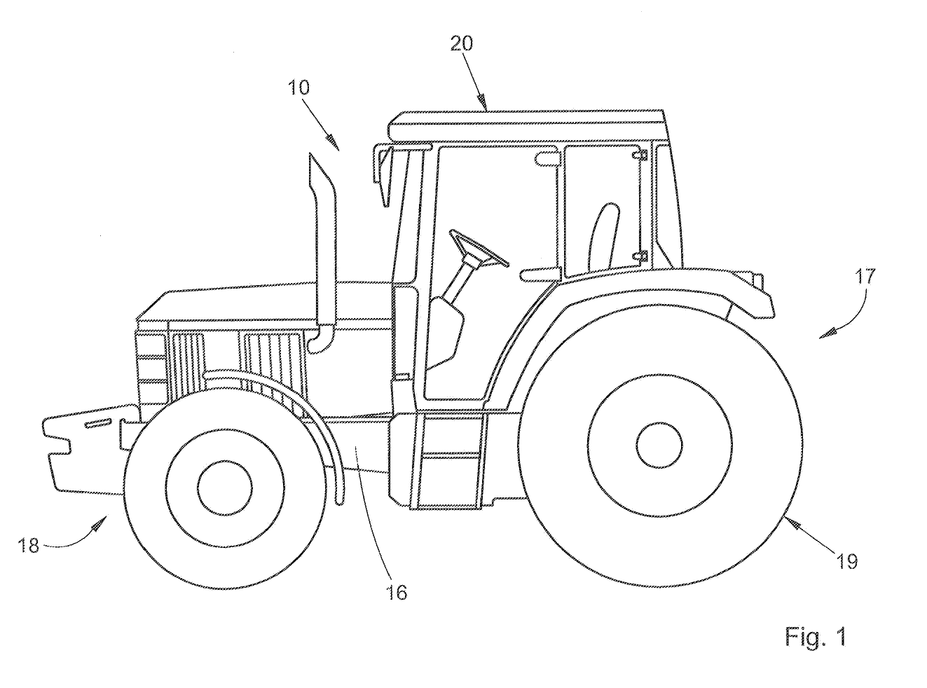

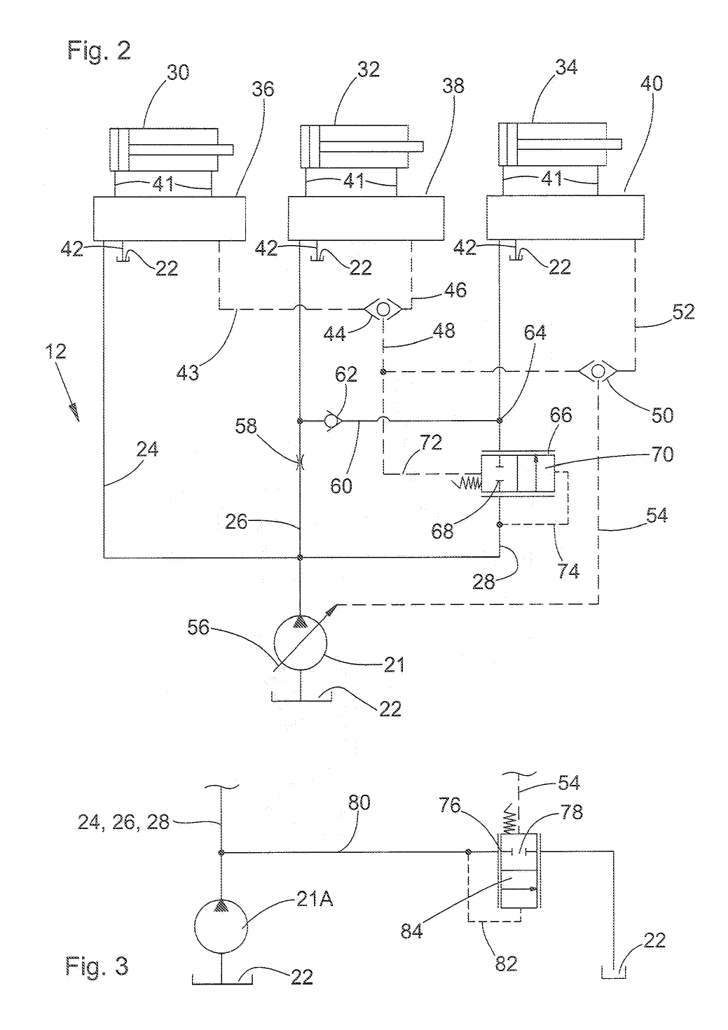

FIG. 1 shows an agricultural vehicle 10 in the form of a tractor, which includes the hydraulic circuit 12 as shown in FIGS. 2 and 3. The hydraulic circuits shown in FIGS. 2 and 3 are described merely by way of example in connection with a tractor and may also be similarly used in other agricultural vehicles, such as harvesters, agricultural chemical applicators, planting and sowing machines, and also in construction and forestry machines.

The vehicle 10 includes a frame 16, on which, for example on a rear area 17, a three-point hitch (not shown) with lifting gear for the operation of attachments or implements (not shown) is arranged. A three-point hitch may similarly also be arranged on a front area of the vehicle 10. A plurality of hydraulic actuators are mounted on the vehicle 10, including a lift cylinder which is part of the three-point hitch. The lift cylinder is supplied with hydraulic fluid from a hydraulic circuit 12 shown in FIGS. 2 and 3. The hydraulic circuit 12 may also supply hydraulically operated attachments (not shown) on the vehicle 10, such as a front loader or a hydraulically operated implement drawn by means of a tow bar.

The vehicle 10 furthermore has a hydraulically operated steering and brake system (neither of which is shown), and a hydraulically operated suspension system on the front axle 18, rear axle 19 and/or a cab 20.

According to FIG. 2 the hydraulic circuit 12 includes a hydraulic pump 21 in the form of a variable-delivery pump, and a hydraulic reservoir 22 in the form of a hydraulic tank with hydraulic fluid.

The hydraulic circuit 12 includes a first, second and third hydraulic supply line 24, 26, 28, which are connected to the pump 21, each of which supplies hydraulic fluid to respective first, second and third hydraulic consumers or actuators 30, 32, 34. Each actuator 30, 32, 34 is controlled by a respective first, second and third control valve 36, 38, 40. The control valves 36, 38, 40 are each connected via one of the supply lines 24, 26, 28 to the pump 21 and via a plurality of different connecting lines 41 to the respective actuator 30, 32, 34, and via tank lines 42 to the hydraulic tank 22. The first actuator 30 is accordingly supplied via the first supply line 24 and is controlled by the control valve 36. The second actuator 32 is accordingly supplied via the supply line 26 and is controlled by the control valve 38. The third actuator 34 is accordingly supplied via the supply line 28 and is controlled by the control valve 40.

Each of the actuators 30, 32, 34 may involve more than just one actuator, so that the first actuator 30, for example, may represent a hydraulically operated steering (not shown) and/or brake system (not shown) of the vehicle 10. The same applies to the second actuator 32 which, for example, may represent a hydraulically operated suspension (not shown) of the vehicle frame 16 on the front axle 18 and/or on the rear axle 19 and/or also a hydraulic suspension (not shown) of the cab 20. The third actuator 34 is likewise here only cited as representative of one or more actuators, for example the lifting gear of a three-point hitch (not shown) or a front loader. The actuators 30, 32, 34 may here also represent other unspecified actuators and may be embodied in any other order.

The first control valve 36 has a first load pressure line 43, which in a first shuttle valve 44 is combined with a second load pressure line 46, connected to the second control valve 38, into a first resulting load pressure line 48. The first resulting load pressure line 48 is combined in a second shuttle valve 50 with a third load pressure line 52, connected to the third control valve 40, into a second resulting load pressure line 54. The shuttle valves 44, 50 are each arranged so that a pressure value signaled by the first or second load pressure line 43, 46 is relayed into the first resulting load pressure line, or a pressure value signaled by the first resulting load pressure line 48 or the third load pressure line 52 is relayed into the second resulting load pressure line 54. The second resulting load pressure line 54 is communicated with a flow controller 56 which is integrated into and controls the variable-delivery pump 21.

The first supply line 24 directly connects the pump 21 to the first control valve 36. The second supply line 26 has flow-reducing 58 in the form of a restrictor or orifice plate connected between the pump 21 and the second control valve 38. A connecting line 60, which leads to the third supply line 28 and connects this to the second supply line 26, branches off between the second control valve 38 and the flow-reducer 58. The connecting line has a non-return or check valve 62, which prohibit a flow from the second supply line 26 in the direction of the third supply line 28. Check valve 62 permits a hydraulic flow coming from the third supply line 28 in the direction of the second supply line 26 and prohibits flow in the opposite direction. No hydraulic flow can therefore pass from the second supply line 26 into the third supply line 28 via the connecting line 60.

A priority valve 66 is arranged between a junction 64 of the connecting line 60 with the third supply line 28 and the pump 21. Priority valve 66 is preferably a pressure-controlled proportional valve or a pressure-monitoring valve. The priority valve 66 has a closed position 68 and an open position 70. A first control pressure line 72 communicates the first resulting load pressure line 48 to the priority valve 66 and acts to move valve 66 into its closed position 68. A second control pressure line 74 communicates the third supply line 28 to the opposite side of the priority valve 66, and acts to move valve 66 into its open position 70.

The hydraulic circuit 12 of FIG. 2 is a load pressure-controlled hydraulic circuit with integral priority control for the various actuators 30, 32, 34, which allows the actuators 30, 32, 34 to be activated on demand with different supply priorities. Priority control in this case signifies that the various actuators 30, 32, 34 are assigned to different levels of importance or priority levels and are supplied by the pump 21 with a corresponding supply priority according to their priority level. This means that in the event of a supply shortfall of the overall system or of the hydraulic circuit 12, which can occur in operation, the actuators of a lower priority level continue to receive only a limited hydraulic supply, if any, in order to ensure a continuing full hydraulic supply to actuators of a higher priority level.

For example, a top supply priority may be assigned to the first actuator 30, a medium supply priority to the second actuator 32 and the lowest supply priority to the third actuator 34. This means that if there is an operational supply shortfall of the hydraulic suppliers 36, 38, 40, it will primarily be ensured that the actuator 30 continues to be adequately supplied, and only then will a hydraulic supply be delivered to the second actuator 32 and if still possible to the third actuator 34. This can be achieved by the assembly of the load pressure lines 43, 46, 48 and the control pressure lines 72, 74 in conjunction with the shuttle valve 44 and the priority valve 66, and by the assembly of the flow-reducer 58 and the connecting line 60 arranged with the means 62.

Under normal conditions, a flow delivered by the pump 21 passes, unimpeded or unrestricted, via the first supply line 24 to the first actuator 30, via the priority valve 66, the connecting line 60 and the second supply line 26 (in particular downstream of the flow-reducer 58) to the second actuator 32 and via the priority valve 66 and the third supply line 28 to the third actuator 34. In the event of a supply shortfall of the overall system, the priority valve 66 closes because of the connection to the first resulting load pressure line 48 and prevents or reduces (restricts) flow through the priority valve 66 to the second and third actuators 32, 34 through complete or partial closure of the priority valve 66. At the same time, a flow for the second actuator 32 through the second supply line 26 is led via the flow-reducer 58, and a flow via the connecting line 60 is prevented by check valve 62. The second actuator 32 therefore continues to be hydraulically supplied, albeit with a restricted flow, irrespective of the position of the priority valve 66, even if the priority valve 66 should be fully closed. In the event of a supply shortfall of the overall system, therefore, a minimum supply, with a flow defined by the flow-reducer 58, is delivered to the second actuator 32. A build-up of pressure is generated for the second actuator 32 and its minimum function is ensured. With increasing closure of the priority valve 66, the third actuator 34 is supplied with an ever smaller flow, whereas the first actuator 30 continues to be supplied at maximum flow. Because of the flow-reducer 58, a higher supply priority attaches to the first actuator 30 than to the second actuator 32. The second actuator 32 moreover enjoys a higher supply priority than the third actuator 34, since a minimum flow for the second actuator 32 via the second supply line 26 is ensured even if the priority valve 66 should be fully closed. Three priority levels are therefore established using just one priority valve 66. The flow-reducer 58 is preset so that a minimum flow to the second actuator 32 is guaranteed, while at the same time ensuring that in no operating state can a supply shortfall of the first actuator 30 occur due to the flow then running off via the second supply line 26.

The first actuator 30 could be a hydraulic steering or brake system of the vehicle 10, which has a higher supply priority than a hydraulic suspension for the vehicle 10 or cab 20 embodied as second actuator 32. A hydraulic suspension for a vehicle 10 or cab 20 embodied as second actuator 32 furthermore generally enjoys a higher supply priority than a lift cylinder embodied as third actuator 34. In the present exemplary embodiment the first actuator 30 has therefore been embodied as a steering and/or brake system, the second actuator 32 as a suspension and the third actuator 34 as a lifting cylinder.

Referring now to FIG. 3, the pump 21A may be a constant-delivery pump, instead of the variable-delivery pump of FIG. 2. The result is a load pressure-dependent, demand-controlled hydraulic circuit using a pressure-controlled proportional valve 76, which when pressure-controlled by the second resulting load pressure line 54 is forced into a closed position 78 and when controlled by a control pressure line 82 connected to the evacuation line 80 is forced into an open position 84. The evacuation line 80 is connected to the constant-delivery pump 21A and reduces the evacuation of excess supply fluid (hydraulic fluid delivered by the pump 21A), which is constantly delivered to the supply lines 24, 26, 28, the volumetric delivery corresponding to the load pressure signal supplied by the second resulting load pressure line 54. Such a constant-delivery pump 21A can therefore also serve for a demand-controlled and/or load-pressure dependent supply of the hydraulic consumers 30, 32 and 34.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A hydraulic circuit having a hydraulic pump a first actuator, a second actuator and a third actuator, supplied on demand by the pump, each actuator being connected to the pump by a corresponding control valve and a corresponding first, second and third supply line, the control valves being connected to the pump via a plurality of load pressure lines, a first-level supply priority being assigned to the first actuator, a second-level supply priority subordinate to the first level being assigned to the second actuator and a third-level supply priority subordinate to the second level being assigned to the third actuator, characterized in that:
a connecting line communicates the third supply line with the second supply line;
a load pressure-controlled priority valve is arranged in the third supply line between the pump and the connecting line; and
a flow-reducer is arranged in the second supply line; and
a check valve is arranged in the connecting line to prevent a flow from the second supply line to the third supply line.

2. The hydraulic circuit of claim 1, wherein:
a first load pressure line is connected to the first actuator;
a second load pressure line is connected to the second actuator;
a first shuttle valve communicates the first and second load pressure lines to first resulting load pressure line;
a first control pressure line drives the priority valve towards a closed position and is connected to the first resulting load pressure line; and
a second control pressure line drives the priority valve towards an open position and is connected on a pump side to one of the supply lines.

3. The hydraulic circuit of claim 2, wherein:
a third load pressure line is connected to the third actuator; and
a second shuttle valve communicates the first resulting load pressure line and the third load pressure line into a second resulting load pressure line, the second resulting load pressure line delivering a control pressure for controlling a supply pressure provided by the pump.

4. The hydraulic circuit of claim 1, wherein:
the priority valve is a proportional valve.

5. The hydraulic circuit of claim 1, wherein:
the pump is a load pressure-dependent variable-delivery pump.

6. The hydraulic circuit of claim 1, wherein:
the hydraulic pump is a constant-delivery pump; and
a proportional valve controllable as a function of a load pressure evacuates supply fluid delivered by the constant-delivery pump to a hydraulic tank as a function of the load pressure.
